(19) United States
(12) Patent Application Publication
(10) Pub. No.: US 2006/0017549 A1
(43) Pub. Date: Jan. 26, 2006

(54) Information display on a vehicle

(76) Inventor: Martin Khang Nguyen, Westminster, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/185,200

(22) Filed: Jul. 19, 2005

Related U.S. Application Data
(60) Provisional application No. 60/589,762, filed on Jul. 20, 2004.

(51) Int. Cl. B60Q 1/00; G08B 1/00; G08B 3/00; G08B 23/00

(52) U.S. Cl. 340/425.5; 340/691.6; 340/693.9; 340/531

(57) ABSTRACT

An embodiment of the present invention is a technique to display information. A panel containing information to be seen by public is mounted on a vehicle moving in a designated area. A controller controls the panel and communicates with a remote contact device to report vehicle information while the vehicle is moving in the designated area.

### RELATED APPLICATION

The present application claims the benefit of the U.S. provisional application, titled “Advertising or Public Announcement on Vehicles,” Ser. No. 60/589,762, filed Jul. 20, 2004.

### BACKGROUND

1. Field of the Invention

Embodiments of the invention relate to the field of information technology, and more specifically, to information display.

2. Description of Related Art

Displaying information to the public has become increasingly popular. Advertisements can be shown to the public through mass communication media such as television, radio, newspapers, magazines, etc. Billboards are also created at strategic locations to increase exposure to the public.

Existing methods to expose information to the public on vehicles has a number of drawbacks. One method is to permanently paint a text or an image on a car. This method requires the car to be used exclusively for that purpose, and makes it difficult to change the information. Another method is to contract with a public transportation agency such as a taxicab service or a bus service to carry signage showing the advertisement. This method requires a long-term contract and is not flexible to change the information.

### BRIEF DESCRIPTION OF THE DRAWINGS

Embodiments of the invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a vehicle having information display unit in which one embodiment of the invention can be practiced.

FIG. 3 is a diagram illustrating a controller in which one embodiment of the invention can be practiced.

FIG. 4 is a diagram illustrating a display panel in which one embodiment of the invention can be practiced.

FIG. 5 is a flowchart to illustrate a process to display information on a vehicle according to one embodiment of the invention.

### DESCRIPTION

An embodiment of the present invention is a technique to display information. A panel containing information to be seen by or exposed to the public is attached to or mounted on a vehicle moving in a designated area. A controller controls the panel and communicates with a remote contact device to report vehicle information while the vehicle is moving in the designated area.

In the following description, numerous specific details are set forth. However, it is understood that embodiments of the invention may be practiced without these specific details. In other instances, well-known circuits, structures, and techniques have not been shown in order not to obscure the understanding of this description.

Elements of one embodiment of the invention may be implemented by hardware, firmware, software or any combination thereof. The term hardware generally refers to an element having a physical structure such as electronic, electromagnetic, optical, electro-optical, mechanical, electromechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc.

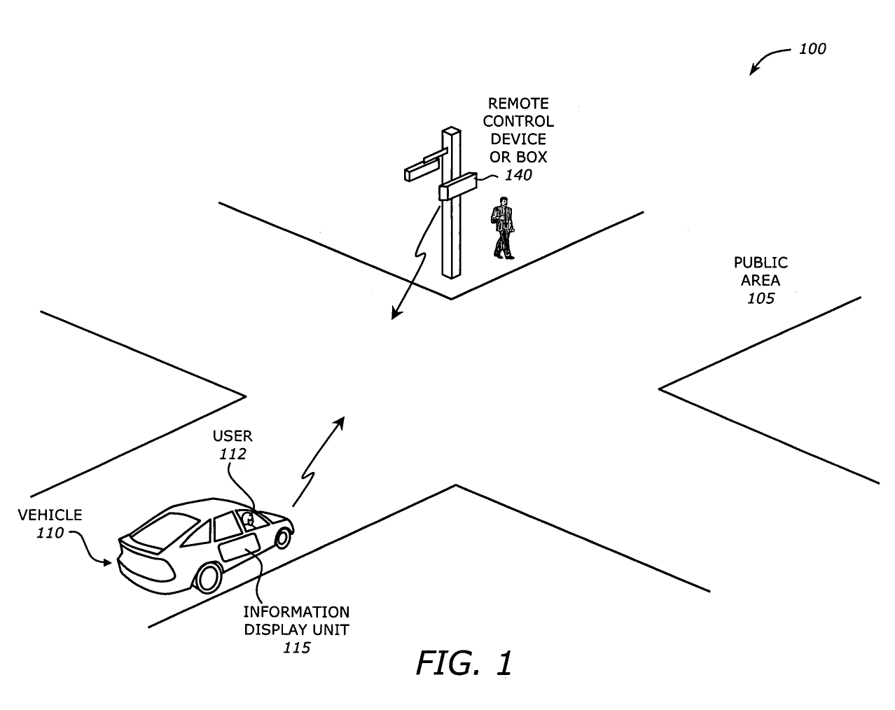

FIG. 1 is a diagram illustrating a system 100 in which one embodiment of the invention can be practiced. The system 100 includes a public area 105, a vehicle 110, and a remote contact box 140.

The system 100 depicts a scenario where information is displayed to the public on a vehicle that moves in a designated area. The vehicle that carries the information may belong to any individual or user. The information may be any type of information that may be of interest to the public, such as advertisements or public announcements. The public announcements may include any announcement to the public such as sports cheering, political rally, lost and found information, personal messages, private party announcements (e.g., wedding, graduation, obituary announcements), etc. In one embodiment, the individual or user may use the vehicle to carry the information as part of an extra income activity or a regular job. He or she may still use the vehicle for normal tasks such as going to work, taking children to school, going on a trip, going on an errand, etc. The individual or the user gets paid for allowing his or her vehicle to carry the information while driving in public places.

The individual or the user may enter into a contract with a middle-person, an agent, or directly to the advertiser, the manufacturer, or the private party who wants the information to be displayed or exposed to the public. The contract may specify the area designated for information display, the location or place that the vehicle should be driven around, the manner to report miles driven, places visited, the length of time the vehicle is used for such purposes, etc.

The public area 105 is any area or place that is exposed to the public or used by the public. It may be as large as an entire metropolitan area or as small as consisting of a few blocks in a city. It may include a park, city streets, highways, freeways, bridges, waters, etc. It may be used as a part of normal daily public activities, in a public gathering such as rally, demonstration, concert, sports event, county fair, etc. The public includes a number of people or individuals who may go, travel, walk, drive, swim, bike, congregate, gather, or move through the area 105 for any purposes.

The vehicle 110 may be any vehicle that can be driven or moved around the public area 105. It may be an automobile, a truck, a sports utility vehicle (SUV), a bus, a station wagon, a motorcycle, a scooter, a bike, a train, a remote controlled vehicle, a boat, a ship, an airplane, a remote controlled airplane, a motorized unit for the disabled, a blimp, a balloon, a buoyant device, etc. The vehicle 110 is driven or controlled by an individual, an entity, or a user 112 to move around the public area. It may be rented, leased, or bought by the individual, entity, or user or by the middle-person or the contracting party for the purpose of displaying or transmitting the information to the public. It carries, distributes, transmits, or displays the information to expose it to the public. It is configured to carry or display the information when it is moved or stationary in the public area 105. It includes an information display unit 115.

The remote contact box or device 140 provides a means to communicate with the information display unit 115. It may be installed or located at various places in the public area 105 around which the vehicle 110 is driven or moved. The communication between the remote contact box 140 and the information display unit 115 may be wireless using sonic (e.g., ultrasound), optical (e.g., laser, infrared), or electromagnetic (e.g., radio frequency, Bluetooth, Wireless Fidelity, etc.) or may be through an intermediate communication medium such as satellites. In one embodiment, radio frequency identification (RFID) technology may also be employed. The remote contact box provides a means to track the movement of the vehicle 110 in the designated area 105. Typically, more than one remote contact box 140 are installed or located near or at strategic locations. These locations may be intersections, cross-streets, traffic poles, traffic lights, well-known landmarks, stores, shops, restaurants, government buildings, etc. The remote contact box 140 may also be located at the place belonging to the middle-person, middle entity, the agent, the advertiser, the manufacturer, or the party that pays for the information display service, etc. This may allow the individual, entity, or user 112 to transmit movement records or vehicle information for verification, record keeping, and/or payment. The user 112 may also download information via the information display unit 115. The user 112 may also download the information using a computer, a notebook, or any networked device and then transfer the downloaded information to the information display unit 115 either by a wired or wireless connectivity. The remote contact device 140 may be connected, in a wireless or wired connectivity, to a processing system or a central system controller to collect, compile, analyze, and process the data received from the vehicle 110. In one embodiment, there may be several vehicles carrying the information in the same manner as the vehicle 110 traveling in the area 105 or in areas that overlap with the area 105. There may also be several remote contact boxes or devices communicating with these vehicles in the same manner as the remote contact box 140. The central system controller, therefore, collects all of the information reported by the various vehicles through the various remote contact boxes or devices in the area. The central system controller then may analyze and verify if the vehicles indeed travel through the designated area with sufficient exposure time as specified in the contract or agreement.

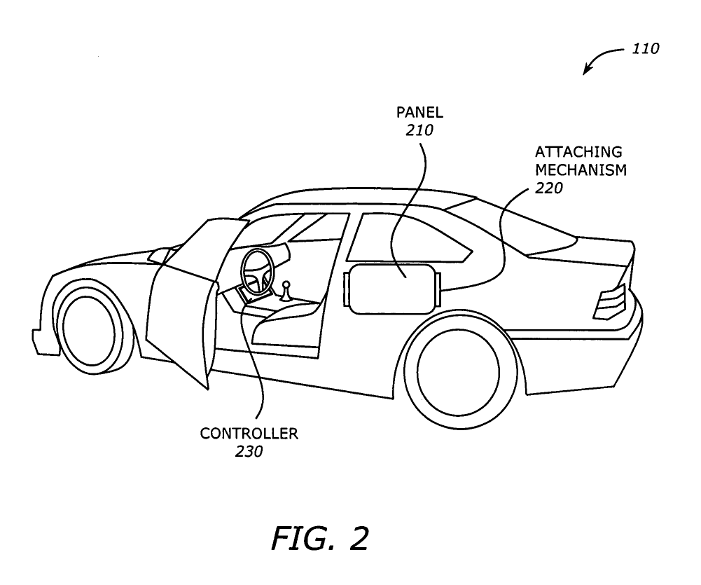

FIG. 2 is a diagram illustrating the vehicle 110 having the information display unit 115 in which one embodiment of the invention can be practiced. The information display unit 115 includes a panel 210, an attaching mechanism 220, and a controller 230. Any of these elements may be located at any suitable location in the vehicle. For illustrative purposes, the vehicle 110 is shown as an automobile. It is contemplated that any other type of vehicle may be used as discussed above.

The panel 210 is a panel, placard, poster, board, or any material that contains the information. It may contain images, audio, or textual information. The information may be mechanical or electronic or any combination of mechanical and electronic. The panel 210 may include a mechanical display panel. It may be a cardboard, or poster, or any template to contain the information. The information may be pasted, engraved, written, painted, etc, on the panel. The panel 210 may include an electronic display panel. The display may be of any type of display including Light Emitting Diode (LED), Liquid Crystal Display (LCD), flat panel display, plasma display, etc. The panel 210 may be made of any suitable materials or construction to facilitate attaching to or mounting it on the vehicle 110. The attachment or mounting area on the vehicle 110 may be any suitable area such as a side window, a side door, a license plate frame, a deck, a wing, a roof, etc. depending on the type of the vehicle 110. In one embodiment, the panel 210 may be optional and the information may be directly attached to the attachment area by painting, sticking, adhesion, etc. For example, the information may include individual of cardboard letters that form a message. The cardboard letters may be attached directly to a part of the vehicle 110 without first being mounted on the panel 210. As another example, the information may be represented by a glass light similar to a neon signage. The glass light may be made by a glass tube that may emit light and may be in a form of a message, a graphic, an icon, or any symbol representing the information. The size of the panel 210 may be any suitable size depending on the information and the type of the vehicle 110. For example, it may be small to fit in a license plate frame of an automobile.

The attaching mechanism 220 is a mechanism to attach or mount the panel 210 or the information to a part of the vehicle 110. Depending on the type of the panel 210 or the information, the attaching mechanism 220 may be mechanical, magnetic, adhesive, etc. The attaching mechanism 220 may not be necessary if the panel 210 is made of a material or constructed such that the panel 210 or the information can be directly attached to the part of the vehicle 110. The attaching mechanism 220 may include a suction cup mechanism that adheres the panel 210 to the surface of the part (e.g., window, side door) of the vehicle. The panel 210 may be attached on the inside or outside of the window(s) or door of the vehicle 110.

The controller 230 is connected to the panel 210 and contains devices or circuits to control the panel 210 and/or to communicate with the remote contact device 140 to report vehicle information while the vehicle 110 is moving or stationary in the designated area 105. The controller 230 may be located inside the vehicle 110 or as a part of the panel 210. It may be powered by battery, wired or plug into the car battery power system either directly or through other means such as the cigarette lighter plug. The power may be continuously provided even when the engine is shut off to provide continuous power to the controller 230 and the panel 210 if necessary. The controller 230 may also be a cellular unit (e.g., a cell phone), a personal digital assistant (PDA), or any wireless communication device. The controller 230 may download information from the remote contact device 140 to update, change, or modify the information displayed on the panel 210.

Any one of the panel 210, the attaching mechanism 220, and the controller 230 may be removed temporarily or permanently when necessary. For example, when the contract is terminated, the user 112 may remove all of these items and return to the agent or the contracting party. In another scenario, the user 112 may just remove the panel 210 and/or the attaching mechanism 220 temporarily such as when the vehicle is being serviced (e.g., repaired or washed) or when the user 112 does not wish his or her vehicle to carry the information for any reasons, or when the user 112 uses the vehicle outside the designated area or outside the contracting hours of operation. This provides flexibility for the user 112 to uses his or her vehicle according to his or her needs. In addition, the panel 210 may be foldable so that it can be easily removed. The panel 210 may also be designed such that it can be used for other functions such as providing shades or decoration to the vehicle 110 in addition to the information display function.

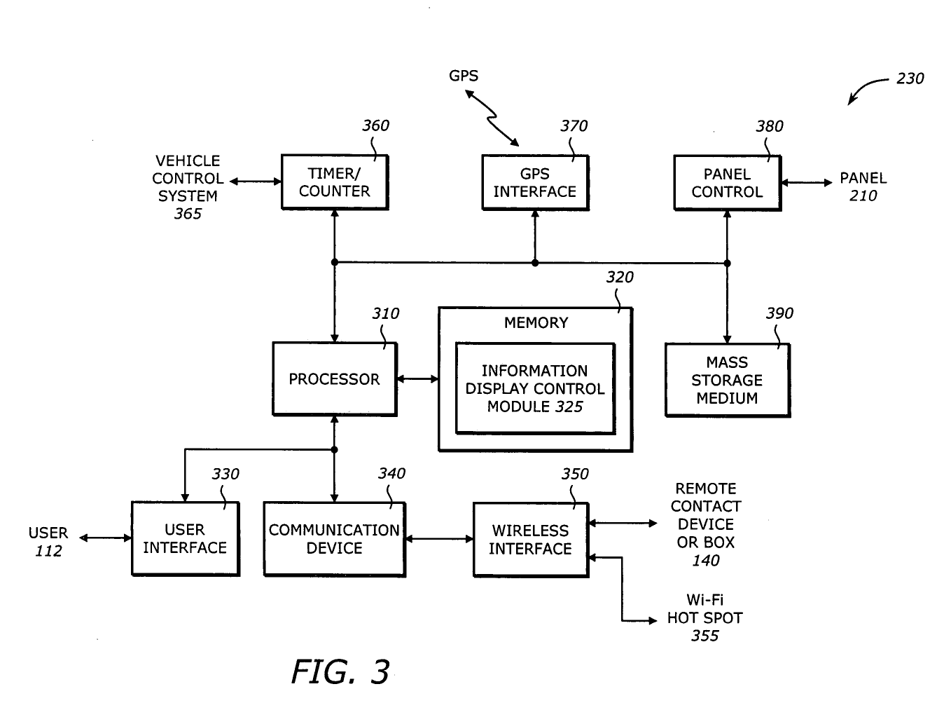

FIG. 3 is a diagram illustrating a controller 230 in which one embodiment of the invention can be practiced. The controller 230 includes a processor 310, a memory 320, a user interface 330, a communication device 340, a timer/counter 360, a Global Positioning System (GPS) interface 370, a panel control 380, and a mass storage medium 390. It is contemplated that the controller 230 may contain more or less than these elements. The controller 230 may also be configured to perform other functions in addition to the control function in the information display unit 115. For example, the controller 230 may be a cellular phone, a PDA, etc.

The processor 310 represents a central processing unit of any type of architecture, such as embedded processors, single core processors, multi-core processors, mobile processors, micro-controllers, digital signal processors, super-scalar computers, vector processors, single instruction multiple data (SIMD) computers, complex instruction set computers (CISC), reduced instruction set computers (RISC), very long instruction word (VLIW), or hybrid architecture.

The processor 310 is typically interfaced to a memory controller (not shown). The memory controller provides control and configuration of memory and input/output devices such as the memory 320 and other input/ output (I/O) devices. The memory controller may be integrated into a chipset that integrates multiple functionalities such as graphics, media, host-to-peripheral bus interface, memory control, power management, etc. The memory controller or its memory control functionality in the may be integrated in the processor 310. In some embodiments, the memory controller, either internal or external to the processor 310, may work for all cores or processors in the processor 310. In other embodiments, it may include different portions that may work separately for different cores or processors in the processor 310.

The memory 320 stores system code and data. The memory 320 is typically implemented with dynamic random access memory (DRAM) or static random access memory (SRAM), or any other types of memories including those that do not need to be refreshed. The memory 320 may include program code or code segments implementing one embodiment of the invention. The memory 320 may include an information display control module 325. Any one of the elements of the information display control module 325 may be implemented by hardware, software, firmware, microcode, or any combination thereof. The memory 320 may also include other programs or data which are not shown, such as an operating system.

The memory controller or the processor 310 may also be interfaced to an I/O controller (not shown). The I/O controller has a number of functionalities that are designed to support I/O functions. It may also be integrated into a chipset together or separate from the memory controller to perform I/O functions. It may include a number of interface and I/O functions such as bus interface, processor interface, interrupt controller, direct memory access (DMA) controller, power management logic, timer, system management bus (SMBus), universal serial bus (USB) interface, mass storage interface, low pin count (LPC) interface, etc.

The user interface 330 provides interface to the user 112. The interface may include a keyboard, a display, buttons, switches, or any other inputs or outputs to allow the user 112 to enter commands or instructions and to receive feedback information, status, menu selection, or any other useful and/or relevant information. The user interface 330 may also include interface to a card reader, a scanner, or any other input device to read data from an input.

The communication device 340 communicates with devices that are external to the vehicle 110 such as the remote contact device 140 or a Wi-Fi or hot spot 355 via a wireless interface 350. The wireless interface 350 provides a wireless connectivity such as electromagnetic (e.g., radio frequency), optical (e.g., laser, infrared), and sonic (e.g., ultrasound). The communication device 340 communicates with the remote contact device 140 to report vehicle information such as vehicle identifier, vehicle location, mileage, engine running time, user identifier, etc. As the vehicle 110 moves around the designated area 105, the communication device 340 continuously communicates or transmits information to various remote contact devices installed around the designated area 105. By collecting the vehicle information throughout the area 105, the remote contact devices may compile the complete movement history of the vehicle 110 to verify or confirm its activities or traveling paths. The communication device 340 may also allow the information from the remote contact device 140 to download control information/data or any relevant information to update, change, or initialize the information or the vehicle information.

The timer/counter 360 is interfaced to the vehicle control system 365 to obtain vehicle information. The vehicle information may include the time the vehicle is driven or stationary, the time the engine has been running, the mileage, the instantaneous time, or any relevant information.

The GPS interface 370 is interfaced to the GPS to obtain the vehicle location information and the timing information. In some vehicles, the GPS interface may already exist in which case the GPS interface 370 merely interfaces directly to the existing GPS interface or may not be needed. The GPS location and timing information may become the vehicle information to be transmitted to the remote contact box or device 140.

The panel control 380 provides control functionality to the panel 210. The control functions may include display control, message control, etc. For example, if the panel 210 is an electronic display panel, the panel control 380 may provide textual or graphic information for display. The panel control may also provide control functions to the attaching mechanism 220 such as electrical signals to activate or deactivate mechanical switches, relays, or other electronic or electromechanical components to control the attaching mechanism 220.

The mass storage medium 390 stores archive information such as code, programs, files, data, applications, and operating systems. The mass storage medium 390 may include a compact disk (CD) read-only memory (ROM), a floppy drive, a hard drive, and a digital video/versatile disc (DVD), and any other magnetic or optic storage devices. The mass storage medium 390 provides a mechanism to read machine-accessible media. The machine-accessible media may contain computer readable program code to perform tasks as described in the following.

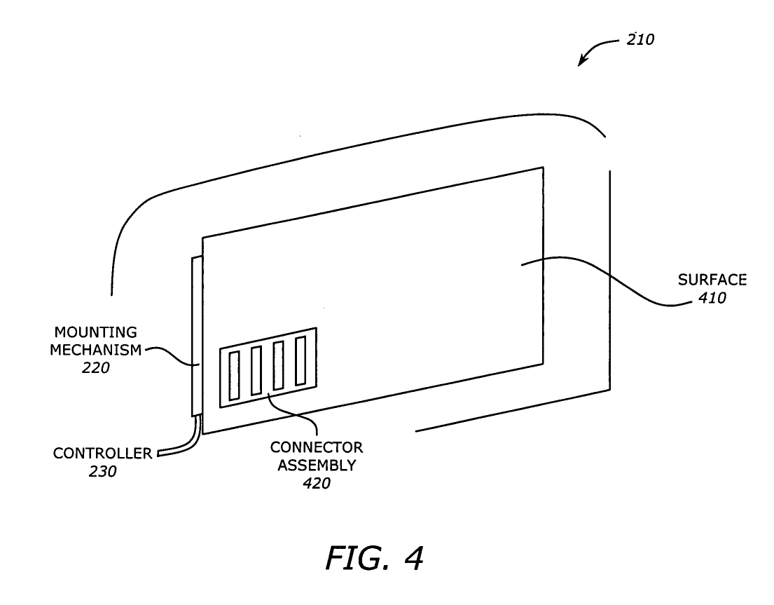

FIG. 4 is a diagram illustrating a display panel 210 in which one embodiment of the invention can be practiced. The display panel 210 includes a surface 410 and a connector assembly 420.

The surface 410 contain the information. The information may be electronic or mechanical. It is mounted or attached to the attaching mechanism 220. The surface 410 may be flat or curved to fit the surface of the mounting or attachment area of the vehicle. For example, if the attachment area is the side window, the surface 410 may be flat. If the attachment area is the external area of the side door of the vehicle, the surface 410 may be slightly curved to fit the surface of the door. The surface 410 may also be foldable or easily removable. For example, the surface 410 may be used as a shade to reflect the sunlight and at the same time to serve as the information display.

The connector assembly 420 may contain one or more conductors. The side of the connector assembly 420 that connects to the controller 230 may be permanently or locked in some way onto the vehicle to prevent it from being removed. There may be a sensing mechanism or a status signal generator such that when such an unauthorized removal is attempted, a signal or status data is sent to a remote contact box 140 or to the central system controller. In this way, the agent, advertiser, the middle-person, or the contractor can be sure that the panel 210 remains to be controlled by the controller 230. The connector assembly 205 may be a flat connector with exposed conductors on both sides of the connector such that it is easy for the individual to peel off the textual or graphical information to replace or remove the information for a certain period of time. In another embodiment, the connector assembly 205 may include one or more magnetic switches such that one side of the connector is inside the glass window and the other side is attached to the image on the outside. Yet, in another embodiment, the connector assembly 420 may contain circuitry for wireless connectivity so that the controller 230 may control or communicate with the surface 410 wirelessly.

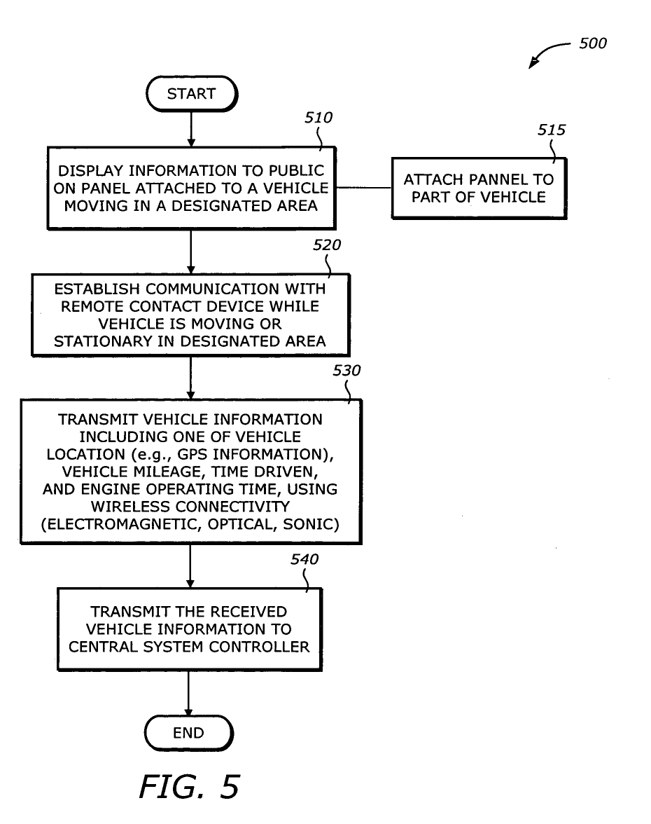

FIG. 5 is a flowchart to illustrate a process 500 to display information on a vehicle according to one embodiment of the invention.

Upon START, the process 500 displays the information to the public on a panel attached to a vehicle moving in a designated area (Block 510). The information may include an advertisement, an announcement, a personal message, etc. The vehicle may be any moving object that may or may not carry a driver or an operator. This may include an automobile, a truck, a bus, a remote controlled vehicle, a motorcycle, a scooter, a balloon, a blimp, an airplane, a remote-controlled airplane, etc. The information display may be performed by attaching the panel to a part of the vehicle (Block 515).

Then, the process 500 establishes communication with a remote contact device while the vehicle is moving or stationary in the designated area (Block 520). There may be more than one such remote contact device in the area. Next, the process 500 transmits the vehicle information including one of vehicle location, vehicle mileage, time drive, and engine operating time (Block 530). Then, the remote contact device transmits the received vehicle information to a central system controller (Block 540). The central system controller may collect such vehicle information from more than one vehicle. Next, the process 500 is terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a panel containing information exposed to public, the panel being attached to or mounted on a vehicle moving in a designated area; and
a controller coupled to the panel to control the panel and to communicate with a remote contact device to report vehicle information while the vehicle is moving in the designated area.

2. The apparatus of claim 1 wherein the panel comprises:
a display to display graphical, image, or textual information.

3. The apparatus of claim 1 wherein the display is mechanical or electronic.

4. The apparatus of claim 1 further comprising:
an attaching mechanism coupled to the panel to attach the panel to the vehicle at an attachment area.

5. The apparatus of claim 4 wherein the attachment area is inside or outside of the vehicle.

6. The apparatus of claim 5 wherein the attachment area is one of a side window, a side door, a license plate frame, a deck, a wing, a roof, and a part of the vehicle.

7. The apparatus of claim 4 wherein the attachment mechanism comprises one of an adhesive plastic, a magnetic material, and a suction cup.

8. The apparatus of claim 1 wherein the controller comprises:
a communication device to communicate with the remote contact device via a wireless connectivity to report vehicle information or to download control information.

9. The apparatus of claim 8 wherein the wireless connectivity is electromagnetic, optical, and sonic.

10. The apparatus of claim 1 wherein the controller comprises:
a timer/counter interfaced to vehicle control system to obtain vehicle information.

11. The apparatus of claim 10 wherein the vehicle information includes one of a vehicle mileage, time that the vehicle is driven, and engine operating time.

12. The apparatus of claim 1 wherein the controller comprises:
an interface to interface to a Global Positioning System (GPS) to obtain location information of the vehicle.

13. A method comprising:
displaying information exposed to public on a panel attached to or mounted on a vehicle moving in a designated area; and
communicating with a remote contact device to report vehicle information while the vehicle is moving in the designated area.

14. The method of claim 13 wherein displaying comprises:
attaching the panel to a part of the vehicle.

15. The method of claim 13 wherein communicating comprises:
transmitting the vehicle information including at least one of user identifier, vehicle identifier, vehicle location, vehicle mileage, time driven, and engine operating time.

16. The method of claim 15 wherein transmitting comprises:
transmitting the vehicle information using a wireless connectivity.

17. The method of claim 16 wherein the wireless connectivity is one of electromagnetic, optical, and sonic.

18. A system comprising:
a remote contact device installed in a designated area; and
a vehicle to move in the designated area to display information, the vehicle comprising:
a panel containing information exposed to public, the panel being attached to or mounted on a part of the vehicle, and
a controller coupled to the panel to control the panel and to communicate with the remote contact device to report vehicle information while the vehicle is moving in the designated area.

19. The system of claim 18 wherein the controller comprises:
a communication device to communicate with the remote contact device via a wireless connectivity.

20. The system of claim 18 wherein the controller comprises:
an interface to interface to a Global Positioning System (GPS) to obtain location information of the vehicle.
